(19) United States
(12) Patent Application Publication
(10) Pub. No.: US 2025/0033708 A1
(43) Pub. Date: Jan. 30, 2025

(54) Tailgate Access Support Rack

(71) Applicant: Samuel Bennet Taylor, Princeville, HI (US)

(72) Inventor: Samuel Bennet Taylor, Princeville, HI (US)

(21) Appl. No.: 18/759,665

(22) Filed: Jun. 28, 2024

Related U.S. Application Data
(60) Provisional application No. 63/516,471, filed on Jul. 28, 2023.

(51) Int. Cl. B62D 33/02

(52) U.S. Cl. CPC B62D 33/0207

(57) ABSTRACT

An after-market crossbar designed for the rear bed of a pickup truck to support equipment and sports gear, freeing the tailgate from being used as support. This lightweight crossbar requires no tools for assembly and easily installs into the pre-existing rear stake holes of pickup trucks. It reclaims the functionality of the tailgate, allowing it to open and close while providing access to the truck bed and its contents. By transferring the weight of the gear off the tailgate and onto the support rack, this invention offers a convenient, cost-effective alternative to existing rack systems. The primary use is to support the load, allowing the tailgate to move freely while carrying gear in the truck bed.

### CROSS-REFERENCE TO RELATED APPLICATIONS

The present application is a non-provisional of U.S. Provisional application under application No. 63/516,471 filed on Jul. 28, 2023 entitled PICKUP TRUCK TAILGATE RACK FOR TRANSPORTING SPORTS EQUIPMENT WITHOUT ENGAGING TAILGATE. Hereby simplified and referred to as TAILGATE ACCESS SUPPORT RACK.

NA

### BACKGROUND OF THE INVENTION

### Field of the Invention

This invention relates to an after-market rack for the bed of a pickup truck. More specifically, it pertains to a support crossbar for equipment placed inside the bed of the pickup truck, when equipment exceeds the length of the bed, without the use of the tailgate in any way.

Outdoor recreation sports have surged in popularity across a diverse demographic in recent years and pickup trucks are the favored transportation used by outdoor sports enthusiasts—the inventor counts himself in both categories.

However, a suboptimal practice among pickup truck-driving-outdoor-sports-enthusiasts has become prevalent—this seemingly innocent habit has effectively nullified the functionality of the tailgate. This practice involves loading gear into the truck bed and resting it on top of the closed tailgate, thereby rendering all other tailgate functions useless. Most pickup truck owners have been guilty of this at some point, and it's a common sight on the road. While this habit is born out of convenience it unfortunately eradicates all the valuable functions of the tailgate, such as providing access to the truck bed and items therein, serving as an outdoor seat, and acting as a fold-down workbench—to name a few.

Thus, a paradox arises: pickup trucks are cherished and acquired for their utility, yet their main utility feature—the tailgate with all its helpful functions—becomes obsolete when used as a gear support. Gear resting on the tailgate makes it difficult or impossible to open, defeating its purpose. The aim of the “Tailgate Access Support Rack” is to restore the function of the tailgate (and access to the contents within the truck bed) while still conveniently transporting sports gear.

### Description of Prior Art

Market leaders like “Thule” and “Backrack” offer solutions to pickup truck owners for securing equipment, but they lack the flexibility and ease of installation desired by an emerging user base. Their systems typically contain a four-posted design that extends vertically several feet above the truck bed walls. They require permanent or semi-permanent installation, often involving professional tools and considerable assembly time, with overall costs that can exceed a thousand dollars.

Other options do exist, but they also require tool assembly, can damage the truck and/or the gear, and they are less convenient and more cost prohibitive than the invention to be described herein.

To sum up prior art, the current pickup truck rack solutions only suit a percentage of the market. The user base has grown considerably to include: weekend users, solo sports men and women, all ages of men and women, multi-sport enthusiasts (who switch equipment from day to day based ocean and wind conditions), and all individuals who face challenges lifting loads overhead (or prefer not to)—to name a few. The ‘Tailgate Access Support Rack’ addresses this shift and growth in the market offering a simplified, convenient, cost-effective solution.

### BRIEF SUMMARY OF INVENTION

The “Tailgate Access Support Rack” is an innovative after-market crossbar designed for the rear bed of pickup trucks. Its primary purpose is to support sports equipment and gear within the truck bed without relying on the tailgate, thus preserving the tailgate's functionality. This solution addresses the common practice among outdoor sports enthusiasts of loading gear onto the tailgate, which obstructs access to the truck bed and compromises the tailgate's usability for other functions. Unlike existing solutions that are often bulky, expensive, and require complex installation, the Tailgate Access Support Rack is lightweight, installs easily into the truck's existing rear stake holes without tools, and maintains a low profile to prevent damage to both the truck and the equipment. It includes features such as integrated tie-down loops and upper side holds to secure equipment and prevent sliding. This invention meets the evolving needs of a diverse market segment, from weekend users to multi-sport enthusiasts, by offering a simplified, convenient, and cost-effective solution for transporting sports gear while ensuring full access to the truck bed and its contents.

### BRIEF DESCRIPTION OF THE DRAWINGS

FIG. 1: A rearview of the Tailgate Access Support Rack in a uni-body (single piece design) showing the crossbar, the legs, the upper holds and the tie down loops.

FIG. 2: A rearview of the Tailgate Access Support Rack in a multi-body design (multi piece design) showing the crossbar in three adjoining pieces, the legs, the upper holds and the tie down loops.

FIG. 3: An overview of the Tailgate Access Support Rack showing the legs about to be inserted into the pre-existing rear stake holes on the truck bed.

FIG. 4: A rearview of the Tailgate Access Support Rack with the tailgate closed.

FIG. 5: A sideview showing how the Tailgate Access Support Rack's crossbar supports the load (a surfboard in this figure) allowing the tailgate to open and close.

FIG. 6: A sideview showing the same surfboard loaded directly on the tailgate without the support of Tailgate Access Support Rack's crossbar.

FIG. 7: A side view of a truck with the tailgate down being used a seat made possible by Tailgate Access Support Rack.

FIG. 8: A rear view of a truck with the tailgate open showing the surfboard clear of the tailgate and supported on the Tailgate Access Support Rack; showing the person able to access his gear inside the truck bed under the surfboard.

FIG. 9: A side view of a truck the with tailgate down being used as a work bench made possible by Tailgate Access Support Rack.

### DETAILED DESCRIPTION OF THE INVENTION

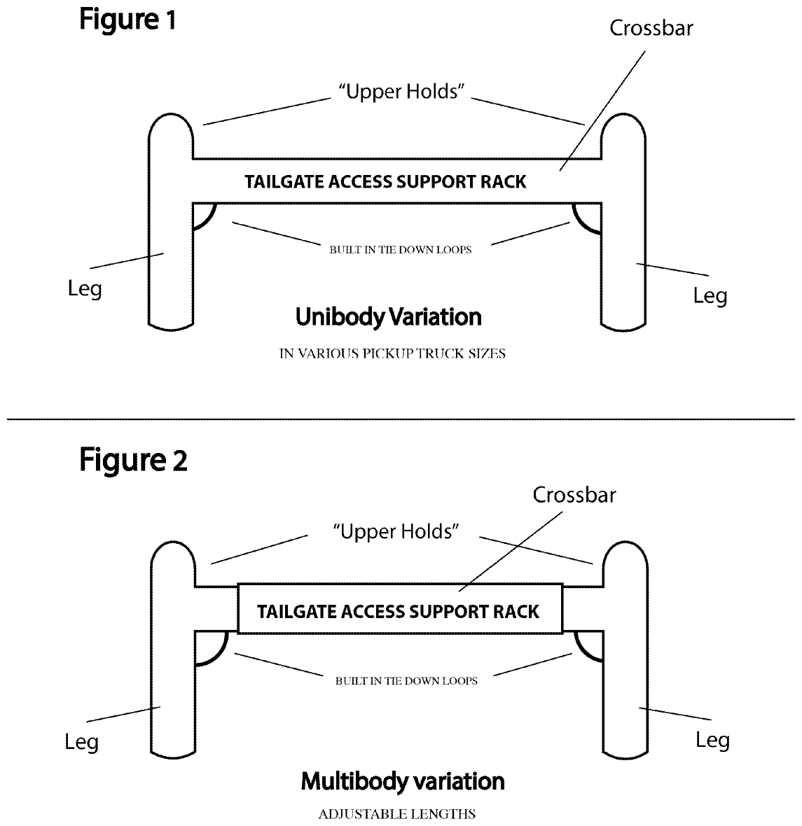

The Tailgate Access Support Rack is a simple construction consisting of a lightweight material in a uni-body variation as in FIG. 1 or a multi-piece construction as in FIG. 2. It includes upper holds on either end of a crossbar and legs that insert into the pre-existing rear stake holes of a truck. The tie down loopholes are integrated into the design and exist to secure the Tailgate Access Support Rack to the truck bed via the truck's tie down anchors.

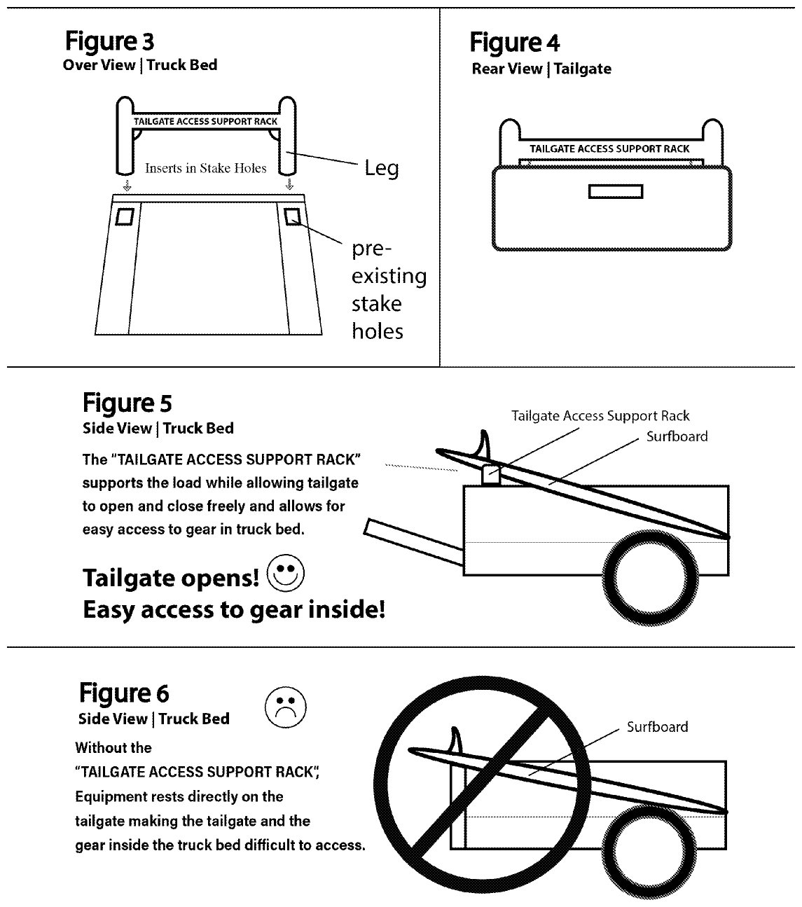

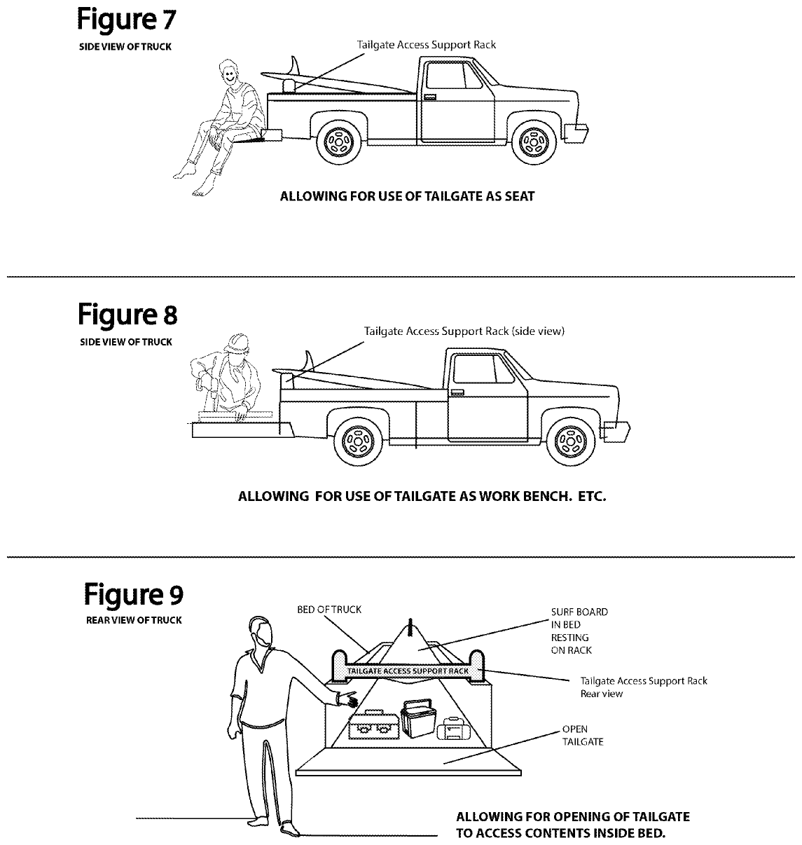

As shown in FIG. 3 the Tailgate Access Support Rack is designed to conveniently fit into the pre-existing rear stake holes of the pickup truck bed, allowing for the opening and closing of the tailgate as shown in FIG. 5. Thus, avoiding the common issue shown in FIG. 6 wherein the tailgate is unable to open or close due to the load resting on the tailgate. With the Tailgate Access Support Rack one may now make full use of the classic purposes of the tailgate as illustrated in FIG. 7: sitting on the tailgate, and in FIG. 8: using as a work bench or table and in FIG. 9: accessing the gear inside the bed.

What is claimed is:

1. A support bar for a pickup truck bed, comprising:
a cylindrical construction designed to fit into the existing rear stake holes of the truck bed
the support bar being low profile, raising only a few inches above the height of the truck bed.
made of lightweight and durable non-corrosive materials
cylindrical body design to ensure no damage to equipment or truck.
requiring no tools for assembly or installation
designed with upper side holds to keep equipment from sliding off.
Integrated tie down loops to lock the bar to vehicle and secure loads.
designed to support and transport equipment within the truck bed while maintaining full function and use of the tailgate and access to contents inside truck bed.

2. The support bar of claim 1, wherein the cylindrical construction ensures easy installation and removal, using the pre-existing rear stake holes without any modifications or damage to the truck, equipment, or rack.

3. The support bar of claim 1, wherein the non-corrosive materials used in construction prevent rust and degradation.

4. The support bar of claim 1, wherein the support bar is designed to prevent damage to sensitive sports equipment, such as expensive fiberglass surfboards and paddleboards.

5. The support bar of claim 1, wherein the design includes variations of widths to fit various truck bed sizes and configurations.

6. The support bar of claim 1, wherein the support bar includes integrated tie-down points to secure the rack to truck.

7. The support bar of claim 1, wherein support bar is uniquely designed with upper side holds to keep equipment from sliding off the support bar.
